(19) United States
(12) Patent Application Publication
(10) Pub. No.: US 2016/0313120 A1
(43) Pub. Date: Oct. 27, 2016

(54) METHOD FOR DETERMINATION OF OPTIMAL FOREST VIDEO MONITORING SYSTEM CONFIGURATION

(71) Applicant: OBSHESTVO S OGRANICHENNOJ OTVETSTVENNOSTYU "DISIKON", Nizhnij Novgorod (RU)

(72) Inventors: Ivan Sergeevich SHISHALOV, Nizhnij Novgorod (RU); Andrei Viktorovich FILIMONOV, s. Kamenki (RU); Oleg Andreevich GROMAZIN, Nizhnij Novgorod (RU); Vladimir Vladimirovich PARKHACHEV, Nizhnij Novgorod (RU)

(21) Appl. No.: 14/895,215

(22) PCT Filed: Oct. 31, 2014
(86) PCT No.: PCT/RU2014/000829

§ 371 Date: Dec. 30, 2015

(30) Foreign Application Priority Data
Dec. 16, 2013 (RU) 2013156177

(51) Int. Cl. G01C 11/04; H04N 5/232; A01G 23/00; H04N 7/18

(52) U.S. Cl. CPC G01C 11/04; H04N 7/181; H04N 5/23216; H04N 5/23206; H04N 5/23296; A01G 23/00

(57) ABSTRACT

The invention is generally attributed to the sphere of video surveillance and, more specifically, to a method of determining an optimal configuration of a forest video monitoring system, comprising a plurality of video monitoring points, each of said points comprising a video camera in a tall structure. A plurality of parameters related to characteristics of monitoring points and characteristics of the territory of their placement are accumulated. Characteristics of the territory comprise landscape characteristics, weather data and forest fire data. Some of the parameters attributed to characteristics of monitoring points are controllable. A system performance criterion is set, being an integral quantity described by a probabilistic model generalizing at least a portion of the parameters. Options of placement of monitoring points are searched through based on a plurality of available positions at the territory by determining an optimal set of parameters optimizing the performance criterion for the determined placement of monitoring points, wherein the performance criterion is calculated by varying the controllable parameters. The optimal configuration of the system is determined by comparing the produced options of placement of monitoring points, for which optimal sets of parameters are determined, and selecting the placement option with the best value of the performance criterion. The invention ensures creation of a method that permits generating precise data for assessment of efficiency of implementation and operation of the forest video monitoring system based on publicly available data and determining an optimal configuration of the system based on such assessment.

### TECHNICAL FIELD

This invention is generally related to the field of video monitoring, particularly, forest video monitoring systems enabling monitoring of forest territories with positioning of detected objects by means of passive optical location for the purpose of early detection of forest fires for the subsequent localization and extinguishing thereof; particularly, to the method for determination of optimal forest video monitoring system configuration.

### BACKGROUND

Forest video monitoring systems designed for detection and positioning of forest fires has been put to use quite recently. However, their applicability has been growing as a problem of forest fires is rightfully considered one of the most serious problems not solved by now. Forest fires occur and cause great damage in many countries of the world, an example of which is forest fires in the territory of the Russian Federation in 2010, which had catastrophic consequences due to, among other things, failure to detect and position them at an early stage, which was discussed in detail in mass media.

Below with reference to FIG. 1 an illustration of base structure of forest video monitoring system is provided. The well-known examples of such systems are ForestWatch (Canada), IPNAS (Croatia), FireWatch (Germany). Similar systems have been designed in the Russian Federation, for instance, “Klen” and “Baltika”.

The forest video monitoring system shown in FIG. 1 generally includes a number of remotely controlled video monitoring points 110 and one or several automated operator workstations 120 connected therewith for proper operation of video monitoring points 110.

The equipment 120 of the operator automated workstation is generally based on the widely known computer and communication technologies and typically includes a computer with remote data exchange capability and special and general-purpose software installed to it. The computer hardware and general-purpose software (for example, operating system) is well known in the art. The term computer can mean personal computer, laptop, a system of interconnected computers, etc. with characteristics in compliance with the requirements to the system 100. The computer is connected to a display, which in the course of computer operation shows a special graphical user interface (GUI) associated with a special application by means of which the operator performs the task of visual territory monitoring and control of video monitoring points 110. Interaction with the graphical user interface elements is performed using well-known input devices connected to the computer, such as keyboard, mouse, etc.

Each video monitoring point 110 essentially represents transmission equipment 111 arranged on a tall structure 112. The tall structure 112 generally can be any tall structure meeting the requirements to the system 110 (i.e. adapted for arrangement of transmission equipment at a sufficient height and providing for an opportunity to monitor a sufficiently big territory) and generally represents a communications provider tower, cellular operator tower, television tower, lighting tower, etc.

The general term “transmission equipment” 111 means equipment arranged on a tall structure 112 including a controlled video unit 113 and a communication module 114 for communication/data exchange with the operator workstation (stations) 120.

The controlled video unit 113 in the general case comprises a digital camera 115 equipped with a zoom system 116 and mounted on a rotating device 117 enabling a change of camera 115 spatial orientation with high accuracy.

The transmission equipment 111 also includes a camera control equipment 118 connected to the communication module 114, camera 115, zoom system 116, and rotating device 117 and designed for general control of controlled video unit 113 in general and components thereof in particular. Thus, receiving control signals from the operator or other device of system 100 through the communication module 114, the control unit 118 can adjust the required spatial orientation of camera 115 (for instance, for pointing it to an object to be monitored) by means of control of the rotating device 117 and/or zoom the monitored object controlling the zooming system 116. Besides, the control unit 118 can determine current spatial orientation of camera 115 and provide data of its current spatial orientation through the communication module 114 to a requester (particularly, to the operator workstation 120 where the data are displayed e.g. in GUI). The above-specified functionalities are well-known features of modern commercially available sets of controlled cameras.

The control unit 118 generally comprises an obvious to a specialist microprocessor-based hardware block such as a controller, microcomputer, etc. specifically programmed or programmable for performance of the assigned functions. The control unit 118 can be programmed by means of recording (configuring) its microcode software (firmware), which is well known in the art. Accordingly, in a typical case, the camera control unit 118 is connected to a memory unit (e.g. integrated flash memory) used for storage of the relevant software (firmware), the execution of which realizes the functions related to the control unit 118.

Operator workstations 120 can be connected to video monitoring points 110 either directly or through a communication network (e.g., network 130) using well-known and widely-used wired and/or wireless, digital and/or analog communication technologies; in this case the communication module 114 of a video monitoring point 110 and the communication interface of the operator workstation 120 shall comply with the communication standards/protocols, on which such communication is based.

Thus, the illustrative network 130, to which video monitoring points and automated operator workstations 120 are connected, can represent an address network such as Internet. If there is a third party provider's communication channel at the place of video monitoring point 110 installation, which is frequently encountered, this channel shall be preferably used for connection of the transmission equipment 111 to Internet. If there is no opportunity of direct connection to Internet at the place of video monitoring point 110 installation, the well-known wireless broadband communication technologies (e.g., Wi-Fi, WiMAX, 3G, etc.) shall be used for provision of communication between the transmission equipment 111 and Internet access point. Operator workstations 120 are connected to the network 130 in a similar way. In particular, for connection to the network 130, depending on the access technology applied, a modem can be used (including wireless one), and also, network interface card (NIC), wireless access board, etc., which can be external or internal in relation to the operator workstation 120 computer.

Usually, system 100 also includes a server 140 connected to the network 130, to which the functions of centralized control of a set of video monitoring points 110 and their interaction with the operator workstations 120 for proper operation of the system 100 are delegated. Server 140 typically represents a high-performance computer or a set of interconnected computers (e.g., a rack of blade servers) with special server software installed and a high-speed Internet connection. The hardware/software implementation of such server is obvious for a specialist. Beside the general functions of system 100 control, server 140 can perform various highly specialized functions, e.g., it can perform the functions of a video server providing for collection and processing of data and submission thereof to the user upon request.

With such method of forest video monitoring system organization, one user can monitor the assigned territory controlling a number of cameras at the same time. Besides, due to the above functionalities, there is a capability of automatic fast detection of a fire area visible from several cameras using a well-known angular method, and also, storage in the memory (e.g., on the server 140 or in the operator workstation computer 120) of predetermined patrolling routes for fast access to them and monitoring. Here a “patrolling route” means a predetermined sequence of camera orientation changes designed for obtaining of visual information on the required predetermined territory. In other words, a route means an algorithm for territory monitoring with a particular camera.

It shall be noted that the performance of modern electronic hardware enables using them as a basis for creation of visualization and control units with the components of forest vide monitoring system providing quite wide user functionality, which largely simplifies the operator's work. Besides, modern hardware in combination with special software executable by them can perform some functions for automatic detection of potentially hazardous objects in video or photo images received from the cameras (in forest monitoring such objects can include smoke, fire, etc.) Such computer vision systems for the search of hazardous objects in images can use a priori information on the features of smoke or fire, e.g., specific motion, color, brightness, etc. Such computer vision systems are used in many sectors of industry from robotics to security systems, which is reported in detail, e.g., in publication Computer vision. A modern approach—D. Forsyth, J. Ponce, Williams Publishing House, 2004, 928 pages.

Such intellectual subsystem using the above computer vision technologies can be generally implemented either on the operator workstation 120, or server 140, or even in the controlled video unit 113.

The additional aspects of forest video monitoring systems connected directly with determination and processing of coordinates of detected objects are specified in more detail, in particular, in patent publications RU 2458407, WO 2012/118403.

It shall be noted that the creation and deployment of such forest video monitoring systems has become possible only in recent years. Only now, the number of cell towers is such that they cover main fire hazardous areas. Besides, the broadband Internet services enabling exchange of big volumes of information and transmission of online video by Internet have become readily available and the cost of equipment for long-distance wireless communication has decreased.

However, the above factors do not remove from the agenda the urgent task of optimization of deployment and/or operation of forest video monitoring system in the controlled area in terms of provision of the acceptable fire detection results and the input of material and technical resources. The first of the above optimization aspects is absolutely obvious due to the above specified basic functional destination of forest video monitoring system as the deployment thereof without the provision of proper quality of is functioning under the basic destination can result at least in more significant damage caused by fires in the area. Considering the second of the above optimization aspects, it shall be assumed that, in spite of the general positive trend noted in the previous paragraph, deployment and operation of forest video monitoring system on-site is connected with considerable input of resources both short-time and continuing. Therefore, the objective to provide satisfactory quality of operation not at any cost but rather in a resource-efficient way is quite natural. The opposite example of inefficiency of deployment/operation of forest video monitoring system is a case when the current resource inputs considerably exceed all damage, which can be potentially caused by fires.

Generally speaking, the process of preparation for introduction, introduction, and control of forest fire detection system in the course of its operation implies the capability to compute a number of figures enabling to:

1) substantiate the introduction economically;

2) compare video monitoring systems to one another;

3) select an optimal system configuration;

4) optimize system settings based on the current environmental conditions. In this case, the criteria used in valuation under items 1-4 can be quite different.

The most important problems are the ones of optimal arrangement of video monitoring points, their type and operating modes. Inefficient arrangement, for instance, can decrease by many times and sometimes decades the capability of video monitoring system to detect potential fires. That is why it is very important to have a tool enabling the selection of optimal video monitoring system configuration under the determined criteria and limits.

Such tasks are faced in communication systems when optimizing the usage of radio spectrum and determination of coverage areas. For solution of these tasks, a number of approaches have been developed and commercial software products have been designed (see, particularly, http://www.itu.int/ITU-D/tech/events/2012/ResultsWRC12_CIS_StPetersburg_June 2/Presentations/Session4/S4_3.pdf, http://ru.scribd.com/doc/55805349/RPS-User-Manual).

The drawbacks of these approaches in the context under consideration include a failure to account for the specifics of particularly optical location and features of operation of optical location systems in conditions of natural lighting; besides, they are not designed for determination of characteristics of detection systems.

There is another class of systems, which are designed for analysis of video monitoring systems in a limited territory, i.e. they help determine how the territory is going to be monitored by the monitoring system (see, e.g., http://www.jvsg.com/ip-video-system-design-tool/, http://www.cctvcad.com/rus/quick_start4_videocad6.pdf, http://www.cctvcad.com/CCTVCAD-Download.html, http://www.algoritm.org/arch/arch.php?id=62&a=1312).

Such approaches account for the specifics of video monitoring, characteristics of optical monitoring equipment (angles of view, resolution). Some of them include optimization methods.

The drawbacks of these approaches in the context under consideration include a poor consideration of specifics of monitoring of big territories. Such systems attach importance only to the fact of coming of the monitoring object to the field of view (e.g., seeing an intruder on the display); in this case the monitoring conditions are considered to be permanent and the probabilistic characteristics are poorly accounted for or not accounted for at all.

### SUMMARY

The objective of this invention is to develop a methodology enabling to obtain sufficiently accurate estimates of efficiency of introduction and/or operation of forest video monitoring system based on public data and knowledge of principles of such systems construction and determine the optimal forest video monitoring system configuration based on such estimates.

Under one aspect of this invention, a method is proposed for determination of optimal configuration of forest video monitoring system including numerous video monitoring points each comprising a camera on a tall structure.

The proposed method includes a stage, at which a number of parameters is collected related to the characteristics of video monitoring points and characteristics of territory of video monitoring points' arrangement. The characteristics of the territory include landscape characteristics, weather data and data of forest fires. At least some of the parameters related to the characteristics of video monitoring points are controllable.

Then, under the method, one or more parameters of forest video monitoring system efficiency are set. Each of the efficiency parameters is an integral value described with a probabilistic model generalizing at least some of the above number of parameters.

Then, under the method, a selection of variants of video monitoring points' arrangement is performed per a number of possible positions in the territory by means of determination of arrangement of video monitoring points and definition of an optimal set of parameters for the determined arrangement of video monitoring points optimizing at least one efficiency parameter from the above one or several forest video monitoring system efficiency parameters; in this case this efficiency parameter is determined with variation of the corresponding controlled parameters.

Finally, under the proposed method, optimal configuration of forest video monitoring system is determined by means of comparison of the obtained variants of video monitoring points' arrangement, for which the optimal sets of parameters have been determined, and selection of an arrangement variant with the best value of the above efficiency parameter.

In the preferred embodiment, the method additionally includes a stage, at which one or more limitations are set to the above efficiency parameter. In this case, video monitoring points' arrangement variants, for which the efficiency parameter does not comply with the set limitations, shall not be accounted for in the above comparison.

The above one or several efficiency parameters can represent a number of forest video monitoring system efficiency parameters; in this case, at least one efficiency parameter mentioned above can be a convolution product of the efficiency parameters from the above set thereof with coefficients characterizing the importance of each separate efficiency parameter.

In the preferred embodiment, the method additionally includes a stage, at which in the course of the above search one or more video monitoring points are excluded from the scope of consideration, the change of position and/or characteristics of which has no considerable influence on the determined optimal configuration of forest video monitoring system.

The above search of variants of video monitoring points' arrangement shall be preferably stopped upon compliance with a predetermined completion condition. A predetermined completion condition can be one of the following: sustained absence of improvement of the above efficiency parameter in performance of the search iterations, reaching the time limits specified for the search, or reaching the predetermined number of iterations. When computing the above at least one efficiency parameter, a prognostic probability of fire in the territory within a period of time is preferably computed, as well as the probability density of realization of particular environmental conditions and a dependence of damage caused with fire on the time of failure to start fire extinguishing and errors in positioning thereof is determined.

Under other aspect of this invention, a method is proposed for optimal configuration of forest video monitoring system including a number of distributed video monitoring points each containing a camera on a tall structure.

The proposed method includes a stage, at which a number of parameters related to characteristics of video monitoring points and characteristics of video monitoring points' arrangement territory are collected. The territory characteristics include landscape characteristics, weather data, and data of forest fires. At least some of the parameters related to characteristics of video monitoring points are controllable.

Then, under the method, at least one parameter of forest video monitoring system efficiency is set. This parameter is an integral value described with a probabilistic model generalizing the above number of parameters.

Then, under the method, an optimal set of parameters is determined optimizing the above at least one video monitoring system efficiency parameter; in this case this efficiency parameter is determined with variation of the controlled parameters.

Finally, under the proposed method, the controllable parameters of forest video monitoring system are corrected to the optimal set of parameters.

Under one of the preferred embodiments, the above correction is performed continuously.

Under other preferred embodiment, the above correction is performed providing that the obtained optimal set of parameters provides for improvement of forest video monitoring system operation in terms of the above at least one efficiency parameter by a value not less than the predetermined threshold.

The above determination of optimal set of parameters shall be preferably completed upon the expiration of predetermined time.

Under another aspect of the invention, forest video monitoring system is proposed including a number of remotely controlled video monitoring points each containing a camera on a tall structure; one or more operator computer terminal; and computerized setting module.

The setting module provides for computation of at least one forest video monitoring system efficiency parameter. This efficiency parameter is an integral value described with a probabilistic model generalizing the collected number of parameters related to characteristics of video monitoring points and characteristics of video monitoring points' arrangement territory. The territory characteristics include landscape characteristics, weather data, and data of forest fires. At least some of the parameters related to characteristics of video monitoring points are controllable.

The setting module is configured to determine an optimal set of parameters, which optimizes the above at least one forest video monitoring system efficiency parameter, where the efficiency parameter is computed iteratively with a search of controllable parameters, and correct the forest video monitoring system controllable parameters to an optimal set of parameters.

In a preferred embodiment, the proposed system includes a server and the setting module is software executed in the server.

In another preferred embodiment, the setting module is software executed in at least one operator computer terminal.

In another preferred embodiment, the setting module is a computer device designed to provide for a capability of data exchange with video monitoring points and operator computer terminals.

### BRIEF DESCRIPTION OF THE DRAWINGS

The above and other aspects and advantages of this invention are specified in the following detailed description with reference to the drawing views, in which:

FIG. 1—schematic partial illustration of forest video monitoring system;

FIG. 2—illustration of fire detection in point (x_{f}, y_{f}) from point (x, y) with error E;

FIG. 3—diagram illustrating the detectability of automatic fire detection algorithm;

FIG. 4—diagram illustrating the system detectability;

FIG. 5—diagram illustrating the fire detection probability density;

FIG. 6—diagram illustrating the dependence of the detectability on the area of fire;

FIG. 7—diagram illustrating the dependence of the detectability on the monitoring time with consideration of increase in the area of fire (solid line) and without consideration thereof (dotted line);

FIG. 8—logical diagram of method for estimation of forest video monitoring system introduction efficiency;

FIG. 9—logical diagram of hybrid evolutionary-genetic algorithm of search of optimal forest video monitoring system configuration;

FIG. 10—logical diagram of method for determination of optimal forest video monitoring system configuration under the invention;

FIG. 11—illustration of provision of detection probability in the territory of interest not less than the specified one;

FIG. 12—comparison of optimal and non-optimal cameras' arrangement method;

FIG. 13—illustration of territory with detection probability not less than the specified one with non-optimal arrangement of cameras, where their installation places are marked with triangles;

FIG. 14—illustration of territory with detection probability not less than the specified one with optimal arrangement of cameras, where their installation places are marked with triangles;

FIG. 15—logical diagram of method for estimation of forest video monitoring system parameters at the setting thereof in the course of operation;

FIG. 16—logical diagram of method for optimal setting of forest video monitoring system under this invention.

### DETAILED DESCRIPTION

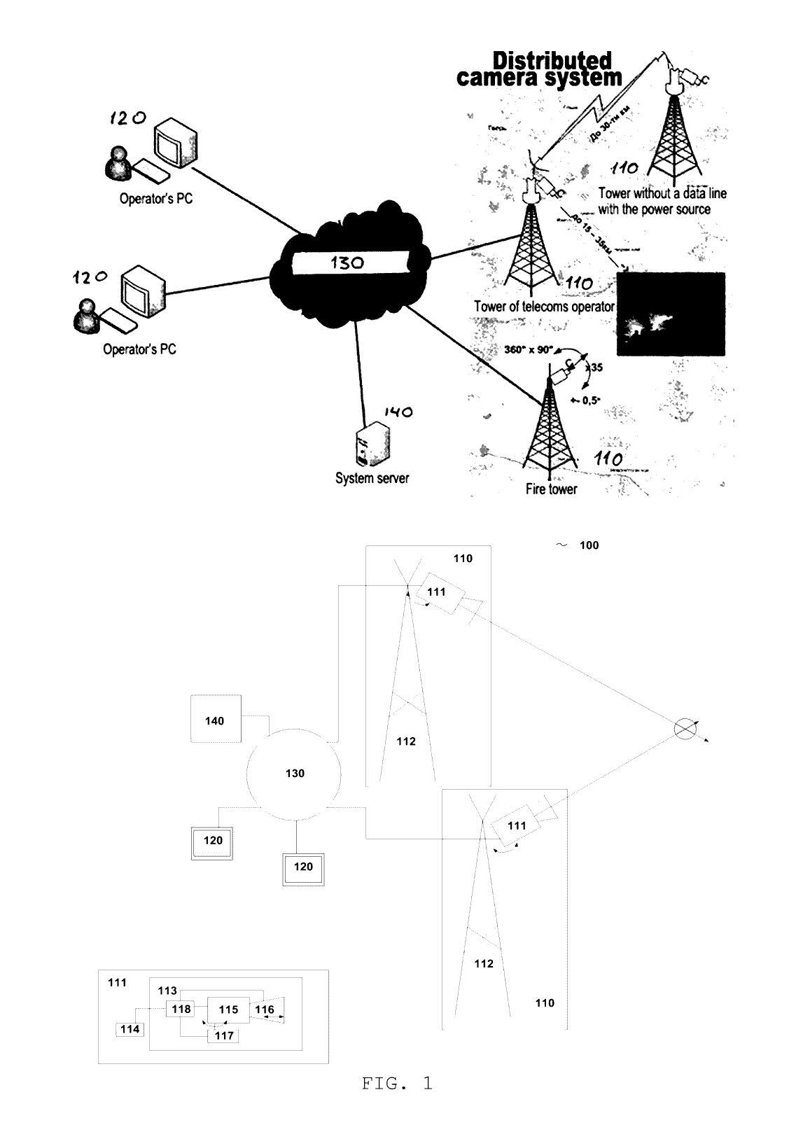

The invention shall be disclosed with reference to forest video monitoring system 100 under FIG. 1; in this case, the description of the system is fully related to the disclosure of this invention.

It is expedient to start the general formulation of problem of forest video monitoring efficiency estimation with the following.

There is quite a big territory, only part of which belongs to the monitoring area (e.g., only part of a region's territory is covered with forest). The territory has a specific terrain and specific conditions of optical signal propagation from a detected object (environmental conditions) determining the nature of object detection process in the territory. It is assumed that to detect a fire, it is necessary to see smoke rising above the edge of the forest or directly an open flame.

The efficiency of the system deployed or to be deployed depends on its configuration—spatial arrangement of video monitoring points, video monitoring points' equipment operation parameters (particularly, route), methods of processing of data received from the points, and other parameters.

In formulation of the efficiency concept, the parameters of radiolocation systems are used (as they are close to the optical location systems under consideration in their technological approach) adopted, e.g., in [1]. As the object to be detected (forest fire) is practically stationary from the point of the territory monitored, the parameters used in determination of the system operational efficiency can be determined as follows:
Undetection probability—probability that an object with the specified parameters was in the territory monitored and the system failed to detect it. The lower the undetection probability, the better is the system;
False alarm probability—probability of giving object presence signal in the absence thereof; usually measured in values per a unit of time or in values per an analyzed signal (volume of information). The lower the false alarm probability, the better is the system;
Time resolution—detection time passed from the moment of object appearance until the moment of detection thereof. The less the time resolution, the better is the system;
Space resolution—accuracy of detected objects' positioning; if two objects are located close to each other, what shall be the minimum distance between them for the system to identify them as different objects. The higher the detection accuracy, the better is the system, i.e. the less the positioning error is.

A set of such parameters can be determined for each point of the territory under consideration and for each system configuration. Obviously, for a fixed system configuration (e.g. in a situation when the system has already been deployed on-site), parameters determined for each of the points in the territory will be different. On the other hand, in the same point of territory the parameters to be determined depend on the configuration of a system to be deployed.

As the system operational efficiency means a number of different parameters, the efficiency concept formalization without adopting a reduction mechanism seems extremely difficult. To formalize the concepts of efficiency and optimality, it is proposed to use a generalized approach to consideration of different parameters by expression of solution in value terms with relevant physical characteristics and losses assumed by such solution. Such method enables convolution of different and sometimes mathematically contradictory system functioning physical parameters to a natural efficiency parameter.

Obviously, as a set of physical characteristics is determined for each point of the territory, it is possible to determine system functioning efficiency in a point of territory. The total system efficiency for the territory can be estimated as a total or average efficiency of all points of the territory.

There are several factors determining the complexity of this problem solution:

1) The complexity of detection process physics. A number of factors influence the fact of detection:
a. Territory characteristics: terrain, non-uniform covering with forest,
b. Weather conditions changing in time for different sections of the territory under consideration;
c. Installation conditions of cameras: installation height, features of installation (e.g., the structure obscures a part of the territory);
d. Influence of particular technical conditions (communication channel width, features of the rotating structure and camera lens, etc.) on the system efficiency;

2) Organizational complexity. The determination of degree of influence of various factors on the efficiency requires a great number of statistical data, which often either do not exist in a form readily available for consideration under the assigned task, or do not exist at all in any form and must be collected independently;

3) Problem technical complexity. The implementation of the problem solution algorithm is technically challenging and the algorithm itself is very labor intensive due to the following reasons:
a. The complexity of computation of the above physical parameters of detectability for a point in the territory. Computations are complex in terms of the number of the required operations and consideration of a great amount of data;
b. Dimension of the problem conditioned with the dimensions of the territory. As it has been mentioned above, the total system efficiency can be estimated as average (in a certain sense) efficiency of all points in the territory. To make an adequate estimation, the number of points considered shall be about 10⁶, i.e. about 10⁶ computations under item 3a shall be made.

The above complexity factors predetermine the development of simplified models for consideration of different factors and effective computation procedures [3], [4] including with utilization of supercomputer technologies and special equipment [5], which is a separate complex technical problem.

The problem of estimation of forest video monitoring system configuration efficiency is considered in a notation determining data units (input, output, intermediate) and processing units making computations on the data.

The following structured information is arranged in input data units.

### I. Information on the Proposed Forest Video Monitoring System:

TABLE 1
Information on the available tall structures

| Tall structure | Geographical coordinates. | | Description of obstruction | Cost of use, monetary | Other |
|---|---|---|---|---|---|
| identifier (ID) | Latitude, longitude | Tower height, m | possibility, degrees | value | parameters |
| Unique foreign key | Usually provided by the tall | Provided by the tall | Follows from the tall | Provided by the telecoms | |
| for organization of | structure owner; it is possible to | structure owner. If this | structure design; provided | operator as a | |
| references from | use data from open sources | information is not available, | by the telecoms operator; | commercial offer. | |
| other data units | http://opensignal.com/ | a default value of 50 m | if this information is | | |
| | | can be taken. | not available, a default | | |
| | | | value of 90° can be taken. | | |

TABLE 2
Information on the possible equipment

| | | | | | | |
|---|---|---|---|---|---|---|
| | Resolution, | | Positioning | Cost, monetary | Cost of operation, | Other |
| Camera ID | pixels | Zoom, degrees | accuracy, degrees | value | monetary value | parameters |

| | | | | | |
|---|---|---|---|---|---|
| Camera model name | Follows from | Follows from | Follows from | Follows from the | Follows from the |
| can be used | the technical | the technical | the technical | commercial offer for | commercial offer of |
| | specification | specification | specification | particular cameras | a service organization |

TABLE 3
Information on the possible system operation modes

| | | Possible point | Parameters describing algorithm of territory |
|---|---|---|---|
| Equipment ID | Description of possible routes | monitoring times | monitoring by the camera |
| Taken from the table of | Taken from the system operation principles, | Value in seconds | In particular, a family of functions describing |
| possible equipment | e.g. camera monitors territory stopping in each | | the computer vision system activity. |
| | point for a certain time. | | |

TABLE 4
Table of parameters of video monitoring points

| | | | Territory monitoring modes' information unit (TMM unit) | | | |
|---|---|---|---|---|---|---|
| | | | | | | Other |
| Cameras' location information unit (CL unit) | | | | Each route point | Settings of computer | pa- |
| Equipment | Tall structure | Structure obstruction | ID of a particular | monitoring time, | vision system | rame- |
| ID | ID | direction, degrees | route used | seconds | parameters | ters |

| | | | | | |
|---|---|---|---|---|---|
| What particular | At what particular | Particular direction, | Type of route used | Territory monitoring | The computer vision |
| equipment | tall structure | which will be | for the given monitoring | time in each route point. | algorithm can include |
| is arranged | the specified | unavailable for | point or a set of successive | Can be specified with | parameters influencing |
| | equipment is to | monitoring with | routes. It is desirable to | the total route | the algorithm |
| | be arranged | this equipment | determine in advance which | monitoring time or | detectability. |
| | | arrangement pattern | routes can be essentially | for a single point. | |
| | | | used as route building | | |
| | | | patterns. | | |

II. [symbol] [symbol] [symbol] :

TABLE 5
Coordinates-related information on the territory characteristics, which are not changing in the course of monitoring

| | | | | | | |
|---|---|---|---|---|---|---|
| | | | | Recreational | | |
| | | | | load on the | | |
| Territory point | | | Forest fire hazard class | territory, | Statistical information on for- | Other |
| coordinates, | | Presence or absence of | (fire hazard class by the | coefficient of | est fires in the territory, | pa- |
| latitude and | Territory point | forest in the territory, | type of forest), class | recreational | probability coefficient or | rame- |
| longitude | altitude, m | yes/no | number | load | statistics | ters |

| | | | | | |
|---|---|---|---|---|---|
| Taken from | Taken from alti- | Taken from open or | Specialized map | This informa- | Kept by special organizations; |
| map data, e.g., | tude map, e.g., | closed information | sources (e.g. used in the | tion is avail- | there are open statistical data: |
| http://www.op | NASAGlobalDig- | sources | Russian Federation un- | able per re- | https://earthdata.nasa.gov/data/ |
| enstreetmap.org/ | italEleva- | http://www.openstreetm | der the government | gions of Russia | near-real-time-data/firms/active- |
| | tionModel | ap.org/ | regulations), e.g., | and is regis- | fire-data#tab-content-6 |
| | (https://lpdaac.usg | There are vector layers | http://www.forestforum. | tered by | There are statistical data in |
| | s.gov/products/ast | with vegetation; there | ru/gis.php | special organi- | Remote Monitoring Infor- |
| | er_products_table/ | are special | | zations (see, | mation System of Federal For- |
| | astgtm) | GREENPEACE maps, | | e.g., [6]) | estry Agency of Russia |
| | | e.g., | | | (ISDM-Rosleskhoz); system |
| | | :http://www.forestforu | | | specification in the closed |
| | | m.ru/gis.php | | | form: |
| | | | | | http://www.aviales.ru/default.a |
| | | | | | spx?textpage=25 |

TABLE 6
Coordinates-related information on the territory characteristics, which are changing in the course
of monitoring (statistical description)

| | | |
|---|---|---|
| Territory point | The statistical description of weather conditions for the point, multi-dimensional probability | [symbol] pyr [symbol] e |
| coordinates, latitude | density based on possible parameters influencing the occurrence probability and detection | [symbol] apa- |
| and longitude | probability (complex factor of fire hazard, air temperature, atmospheric transparency, wind | [symbol] |
| | speed and direction, presence and amount of precipitation, cloud amount, presence and | |
| | characteristics of snow cover, and thunderstorm activity statistics) | |
| The sources of such | These statistical distributions can be computed based on the publicly available monitoring data | |
| data are usually | http://openweathermap.ogr/, http://weather.gladstone family.net/site, http://www.meteo.ru/data | |
| determined by | Official data in the Russian Federation | |
| location-based data, | Information on thunderstorm activity can be obtained at: http://webflash.ess.washington.edu/ | |
| i.e. determined for | | |
| particular points of | | |
| territory | | |

The most important point is the determination of main functions necessary for estimation of efficiency and the dependence between them. Below we shall consider in more detail the examples of methods for computation of such functions and the sources of data for the statistical dependencies. An important factor is the computational complexity of the above functions for real application conditions.

The most complex and fundamental is the estimation of probability of fire detection by the system and the dependence of losses connected with failure to extinguish the fire on the time of detection thereof.

### 1. Estimation of Fire Detection Probability

Let's assume that the camera is hanged in a point with coordinates x, y and height h and the point for which it is necessary to determine fire detection probability has coordinates x_{f}, y_{f} (let's call it a point of interest). For the point of interest under consideration, a type of forest is given determining the fire propagation rate. The distance r between the point of interest and the monitoring point is easy to compute. The terrain determines the optical visibility between these two points. Besides, the main external parameters are specified for the moment of monitoring: atmospheric transparency (visibility range), wind speed, and fire hazard class. Let's assume that the camera monitors the territory around it at a certain horizontal viewing angle and shoots in each direction within the time t.

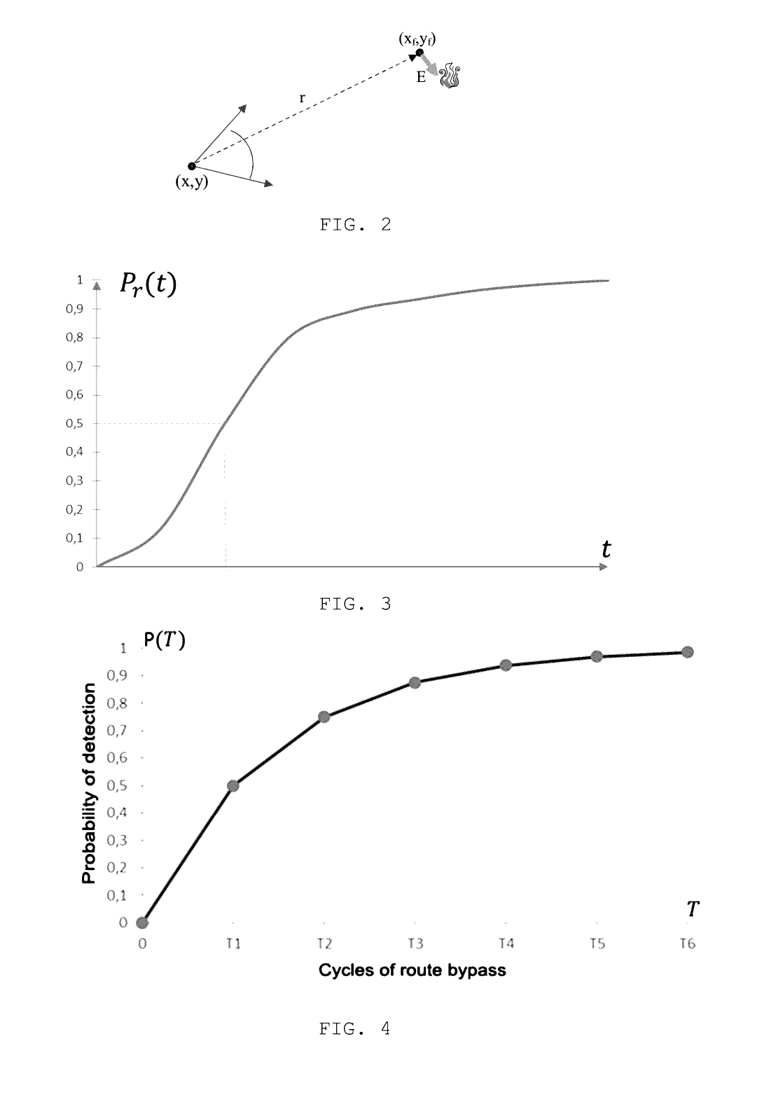

FIG. 2 shows this situation schematically. Let's assume that the fire starts at a zero moment of time and, as the propagation conditions are given (forest type, fire hazard class, wind speed), based on the table data it is possible to determine how the area of fire is going to change in time [8].

Important assumptions: shooting time of each point is much less than the time, within which the fire grows in size considerably, i.e. it can be taken that in the course of shooting in a given direction the fire does not change its size. Within the time between shootings from one point (the camera passes the territory along the predetermined routes and shoots repeatedly to the same direction) external conditions do not change; however, it is considered that each successive monitoring is an event independent from the previous shooting in the same direction in terms of the system detectability.

In order to determine the probability density to detect a fire depending on time, it is necessary to determine how the probability depends on the time of the point of interest monitoring. When building a system aimed to automatic detection of source of fire, this dependence is also determined with the characteristics of automatic detection algorithm. The dependence can be determined based on the statistical study using ready video materials containing images of fires in certain conditions by means of starting an automatic smoke detection algorithm with respect to them. As the accumulation of a comprehensive database of materials with various characteristics of fires and detection conditions can be problematic due to the infrequency of natural fire as a phenomenon, it is possible to simulate the appearance of smoke in certain conditions in an image and study the obtained automatic detection algorithm using the simulated materials.

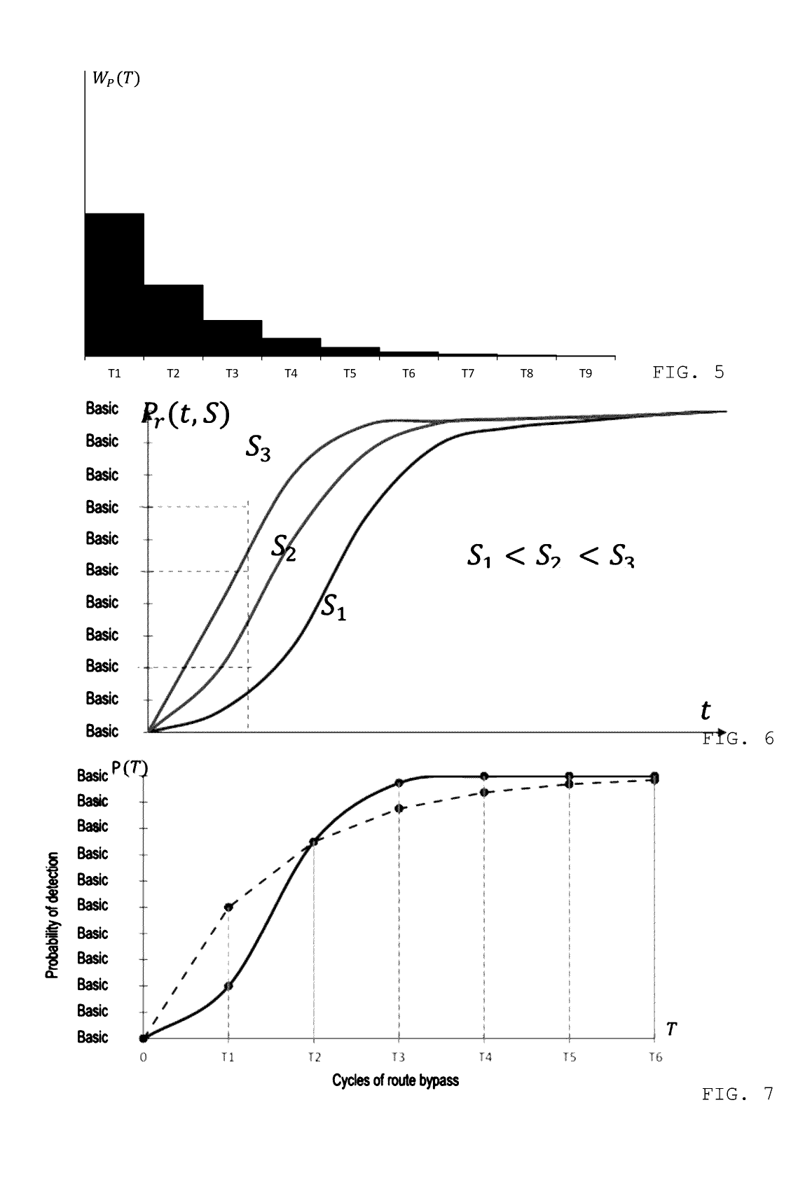

An example of diagram of dependence of fire detection probability in a point of territory on the time of continuous shooting in the point is given in FIG. 3. Let's clarify it once again that this is a dependence of fire detection probability for a given point of the monitored territory on the time of continuous monitoring of this point providing that the fire in this point is present and the environmental parameters, fire size, particular camera zoom, and particular fire location in relation to the camera (in terms of terrain and distance) are fixed.

Using the dependence and the assumption that fire occurs at random moments of time, and also, the assumption that such amount of time passes between two consecutive inspections of the given territory, that the detection in the repeated inspection is statistically independent from the detection in the first inspection, it is possible to determine fire detection probability depending on the time from the occurrence thereof (FIG. 4). In the axis of abscissas there are times specified within which the camera makes 1, 2, 3, etc. circles, or, in other words, returns for a repeated monitoring of the given territory. It shall be explained that, as the rotating camera shoots in turn the positions determined by the route, the probability that until the moment of time T on the interval [0, Tᵢ] the camera has shot point (x_{f}, y_{f}) is linearly dependent on T, reaching 1 in the moment T₁. Actually, as T₁ is the time of completion of full monitoring cycle under the routes, the probability that a particular point of territory will have been monitored by that time is equal to one because all points of interest will have been shot by that moment. As the probability of fire detection in the point is a product of point monitoring probability within the time T by the probability of fire detection in the video record, fire detection probability in the moment of time T₁ is equal to 1*Pᵣ(t). For a point monitoring moment selected in FIG. 4, the detection probability by the moment T₁ is 0.5. By the moment of time T₂ the territory will have been monitored twice, which means that fire detection probability will be 1−(1−Pᵣ(t))². Between points Tᵢ and Tᵢ₊₁ the probability function is determined linearly. Continuing the procedure towards increasing of time, we shall receive a dependence of probability of fire detection in a point of territory on the system functioning time.

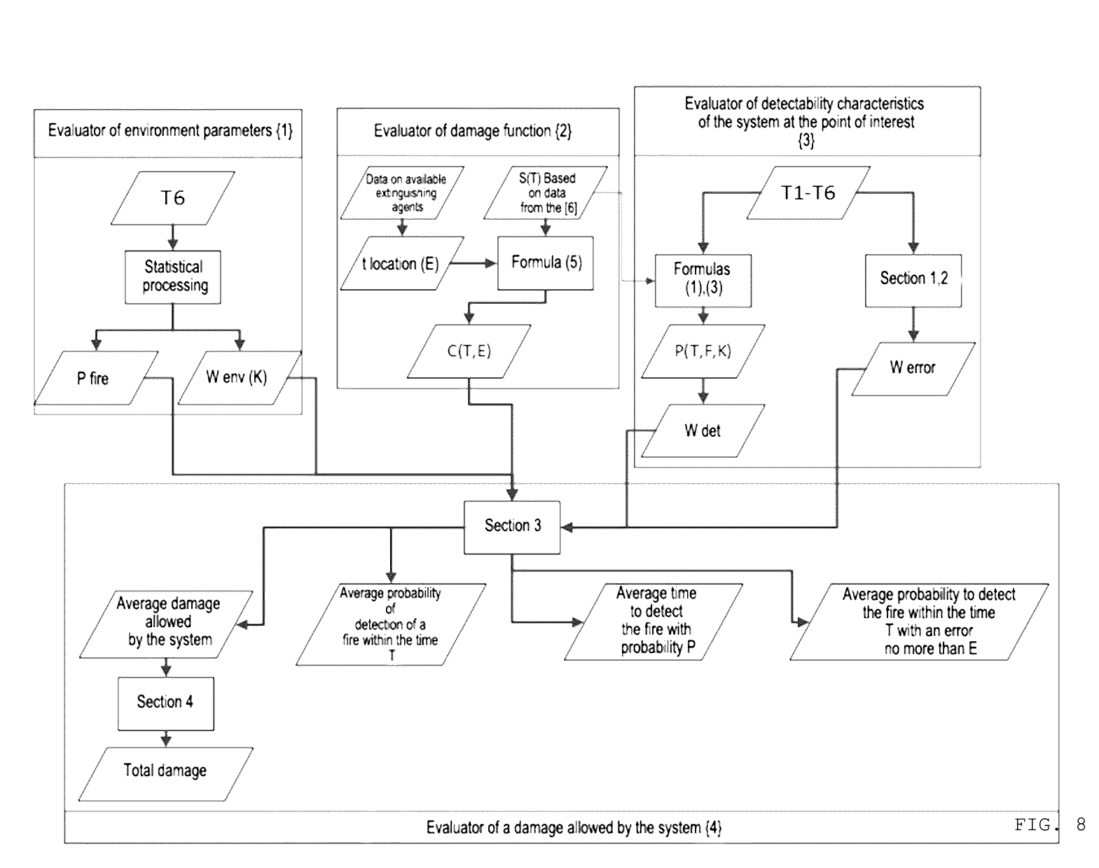

To determine the density of probability of fire detection in a certain moment of time from the moment of its development, it is necessary to take numerically the derivative from the probability of detection depending on time. An example of such probability density is shown in FIG. 5. Actually, it is a desired density of probability of fire detection depending on time W_{det} (see Formula (4) below) for a system consisting of only one camera.

The above reasoning is made based on the assumption that in the course of monitoring the size of fire does not change. In reality the period of completion of territory monitoring route takes tens of minutes or even hours. Considering the fact that fire can be detected at the second, third, etc. passing of monitoring route, its size can considerably increase by that moment, which increases its detection probability. The dependence of fire area on time can be estimated based on the table data specified in different technical guides (e.g., in [7]). Fire detection probability increases with increase of its area and, consequently, visible size. This fact is illustrated in FIG. 6 showing a family of fire detection probability curves depending on the time of shooting of one route position for three different fire areas.

Let the dependence of fire area on the time of burning S(T) is known. Then, repeating the reasoning for FIG. 4, we shall see that the probability of fire detection in the moment of time T1 is equal to Pᵣ(t,S(T1)); in the moment of time T2 is equal to 1−(1−Pᵣ(t,S(T1)))(1−Pᵣ(t,S(T2))), etc. Values P(T) in points different from Ti can be computed by the formula (1), which reflects the fact that fire detection probability depends not only on the algorithm detectability with the selected time of one position shooting t, but also on the probability of point of interest monitoring i times by the moment of time T. The density of probability of point of interest monitoring i times by the time T is equal to 1/T1 in the range from Ti−1 to Ti and 0 in other points. Indeed, the probability of point of interest monitoring i times by the moment of time Ti−1 is equal to 0 and in the moment of time Ti is equal to 1 with linear increasing between these two points.

[symbol]

$$( \text{?} \\ \text{?} \text{indicates text missing or illegible when filed} \qquad ( 1 )$$

These facts are illustrated in FIG. 7. For purposes of clarity, in FIG. 7 dotted line shows the dependence of detection probability without considering the growth of fire area with a fixed size thereof.

Let's consider a more general case when the point of territory is seen from a number of cameras. Let's give an example for two cameras and then let's explain how to extend the reasoning to any number of cameras.

Let's assume that there are two video monitoring points each having its own height, located at its own distance from the monitoring point, and each performing monitoring with its own parameters (angle of view, point monitoring time, algorithm parameters), whereby the environmental conditions can be the same of different. Then for each of the points there will be its own fire detection probability depending on time, correspondingly, P₁(T) and P₂(T) and the probability of detection within the time T by at least one camera will be determined by the following formula:

P(T)=1−(1−P₁(T))(1−P₂(T)) (2)

After differentiating the function, it is possible to obtain the probability density of fire detection by at least one camera depending on time. This method enables to determine the probability density depending on time when monitoring a point of territory from any number of video monitoring points based on the ground that the probability of detection by at least one video monitoring point is inverse to the probability of failure to detect by all video monitoring points altogether:

$$P ( T ) = 1 - {\prod }_{i} ( 1 - {P}_{1} ( T ) ) \qquad ( 3 )$$

### 2. Computation of Positioning Accuracy

The accuracy of determination of coordinates of fire in a point of interest (x_{f}, y_{f}) by a camera in a point (x, y) depends on relative position of the point of interest and camera and does not depend on the monitoring time. The positioning accuracy can characterized by detection probability in point (x_{f}, y_{f}) of fire coordinates with an error EPₑᵣᵣₒᵣ(E) providing that the point was monitored and there was fire in it. However, considering the data in FIG. 7, fire detection probability providing it was in the point of interest is equal to the product of error realization probability E by the probability of fire detection in that point by the time T:

Pₑᵣᵣₒᵣ(E,T)=Pₑᵣᵣₒᵣ(E)P(T).

In this case for two cameras, the error realization function shall have the following form:

$$\text{?} \\ \text{?} \text{indicates text missing or illegible when filed} \qquad ( 4 )$$

where (E) is error realization probability E for i^{th} camera at fire detection by i^{th} camera; Pⁱ(T) probability of detection by i^{th} camera in the moment of time T.

The reasoning related to formula (4) can be extended to any number of cameras. The density probability of error E realization in the moment of time T for a particular point of territory can be obtained naturally from the computed probability density.

3. Dependence of Losses Connected with Failure to Extinguish Fire on the Time of its Detection

The dependence shall include the components of damage connected with the time of failure to extinguish the fire (including connected with the time of detection, accuracy of fire positioning, and cost of failure to extinguish under [9], etc.).

The assumption that the damage depends on the fire area, which, in turn, increases in time, is obvious, i.e. the more the fire area is, the more damage is caused. After the dependence of damage caused by fire on the area is determined, providing that the way the area changes in time is known, it is possible to estimate the dependence of cost of extinguishing on time. This dependence can also account for the fact that the time required to come to each point of territory is different, i.e. a component shall be added determining the addition in time of failure to extinguish the fire depending on the place of its development.

Finally, the damage depends on the area of fire by the moment of start of extinguishing, which, in turn, depends on the time of fire detection after its development and the positioning accuracy. Simple interpretation of dependence of fire area on the accuracy of positioning lies in the fact that in case of inaccurate detection a fire brigade will have to search for the fire on site, which will take time depending on the positioning error, during which the fire will increase in size. This reasoning is expressed in the formula

$$\text{?} , \\ \text{?} \text{indicates text missing or illegible when filed} \qquad ( 5 )$$

where C(S) is the dependence of damage caused by fire on its area; S(T) is the dependence of time of fire location by a fire brigade depending on the detection error E.

In this case, the estimate of average damage caused by the detection system in the point of interest F with particular characteristics of environment Ku, providing there is fire in that point, is

$$\text{?} \\ \text{?} \text{indicates text missing or illegible when filed} \qquad ( 6 )$$

Therefore, the full record of estimate of average damage for the entire territory with the specified probability density of occurrence of particular environmental conditions Wₑₙᵥ and probability of fire development in point F in environmental conditions KW_{fire}(F,K) will be:

$$\text{?} \\ \text{?} \text{indicates text missing or illegible when filed} \qquad ( 7 )$$

It shall be noted that P_{fire} is time-normed, i.e. it has a meaning “fire development probability within a certain period of time”. That is why the estimation of average damage is time-normed in the same sense, i.e. it has a meaning “average damage caused by the detection system within a period of time”.

Besides, a number of criteria shall be considered which can be used for estimation of forest video monitoring system efficiency.

Average Probability of Fire Detection within the Time T:

$$\overline{P \text{?}} ( T ) = {\int }_{S} {\int }_{K} {W}_{okp} ( K ) {W}_{o} ( T , F , K ) d K d F \\ \text{?} \text{indicates text missing or illegible when filed} \qquad ( 8 )$$

Average Time with Fire Detection Probability P:

$$\text{?} \\ \text{?} \text{indicates text missing or illegible when filed} \qquad ( 9 )$$

Average Probability of Fire Detection within the Time T with an Error not More than E:

$$\overline{P \text{?}} ( T , E ) = {\int }_{S} {\int }_{K} {W}_{okp} ( K ) {\int }_{o}^{E} {\int }_{o}^{T} W ( T , F , K ) {W}_{E} ( T , E , F ) d T d E d K d F \\ \text{?} \text{indicates text missing or illegible when filed} \qquad ( 10 )$$

Note that formula (10) enables to answer the following questions:

1) What is the average fire detection probability within the time T with an error E;

2) When constructing inverse function by T: what is the average time spent for detection of fire with the specified accuracy and a probability not less than the specified value;

3) When constructing inverse function by E: with what accuracy is it possible to determine the coordinates of fire within the time T with the specified probability.

Here it is expedient to make a note on the registration of distant towers. Obviously, the accuracy of positioning using one camera and, consequently, contribution to the accuracy of positioning in case of detection by several cameras decreases with increase of distance between the camera and a point of interest. Besides, with increase of distance the detection probability also decreases. These facts make it possible to state that upon the reaching of a certain threshold of distance between the camera and a point of interest, the camera's contribution to the system detection characteristics for a particular point of territory becomes negligible. It means that the computational complexity of computational procedures when estimating the system detectability can be decreased by means of exclusion from consideration of cameras located further from the point of interest than the specified threshold.

### 4. Computation of Economic Efficiency of Fire Detection System Introduction

Let's introduce a concept of full damage in operation of the detection system. The full damage consists of:
1. Average damage c̅ caused by the system within the period of time under consideration;
2. Nonrecurring costs of system deployment C_{deployment},
3. Operating costs C_{operating}: rental of equipment arrangement areas, communication channels, and system maintenance within the period of time under consideration;
4. Costs of human resources (system operators) Cₒₚₑᵣₐₜₒᵣₛ.

The economic efficiency of introduction can be computed as a difference between the potential full damage (items 1-4) after the system introduction and potential full damage (items 1, 3, 4) in case of failure to introduce the system within the period of time under consideration. This approach considers the scenarios when the existing detection system is replaced with a newer one or the video monitoring system is introduced in a territory where there was no other detection system. Thus, the estimate of full damage of the existing system is a combination of items 1, 3, and 4 or, in the absence of the system, only of item 1. In this case the approach determined by the formula (6) can also be applied with a necessary clarification that the probability density of fire detection is a delta function with a peak in the place determining the maximum fire damage and the probability density of realization of accuracy of positioning E is a delta function with a peak corresponding to the probability of occurrence of positioning error 0.

C_{deployment} shall be computed based on the determination of cost of the equipment used and its installation.

Cₒₚₑᵣₐₜₒᵣₛ shall be computed based on the average cost of operator's work in the given area and the number of operators required to operate the system considering the shift schedule. The required number of operators can be estimated by the following methodology. The average number of camera shots F per a unit of time is known. In reality, it amounts to 1.5-2 shots per minute. The number of cameras in the proposed system N is also known. Obviously, the entire system of cameras will generate F×N copies of video material per a unit of time. The automatic detection system allows for a false operation probability P_{fault}, consequently, the average number of false operations per a unit of time in the entire system will be F×N×P_{fault}. It is an estimate of average number of video materials requiring operator's decision generated by the system per a unit of time. Strictly speaking, a decision shall be made not only on materials in which the algorithm admitted false operation, but also on materials, in which the algorithm operated correctly; however, the number of the latter depends on the number of fires in the area per a unit of time and is enormously small as compared to the number of false operations, which makes it possible to neglect this component when determining the operator load. It is known that on the average an operator can make decisions on S video materials per a unit of time (typical figure is 10-20 facts per minute). Thus, the minimum required number of operators can be estimated as follows:

$$\text{?} , \\ \text{?} \text{indicates text missing or illegible when filed} \qquad ( 11 )$$

where K>1 is a reserve coefficient, D is a duration of an operator's shift in hours.

Besides, the estimate can consider that in fire hazardous periods the territory monitoring procedure, besides the monitoring of automatic system activity results, can include direct personal inspection of territory. For such periods, the estimate can be revised as follows:

$$\text{?} \\ \text{?} \text{indicates text missing or illegible when filed} \qquad ( 12 )$$

Computation of costs of operators is an obvious procedure if the required number thereof is known as well as the average cost of an operator with the necessary qualification in the given area.

Below, with reference to FIG. 8 a method is described for determination of damage caused by a forest video monitoring system. As seen, the described method for determination of system efficiency consists of four units.

Unit {1}, based on the statistical processing of historical weather data in the given territory (Table 6 (T6)), computes a prognostic probability of fire in the territory within the period of time under consideration P_{fire} and the probability density of realization of particular environmental conditions W_{env.}(K). It shall be noted that the prognostic probability of fire can be estimated based on historical data of fires in the territory in fire hazardous seasons and using different methods for prediction of fire development probability based on the assumed fire hazard classes considering the possible weather conditions in the territory.

Unit {2} constructs a function C(T,E) of estimation of damage caused by fire on the time of failure to extinguish it and error in its positioning (see formula (5)). The dependence is determined based on:

1) The data of dependence of fire area on time (in other words, data of fire propagation rate for a forest in the given territory);

2) The date on the cost of forest per a unit of forest area;

3) The data on the time of location of a fire source by a fire brigade with a certain fire positioning error made by the system.

Unit {3}, based on the data from Tables 1-6 (T1-T6), under the approaches described above in sections 1, 2, using formulas (1), (3), generates a procedure for computing the following fundamental detection characteristics of the system for each point of the monitored territory:

1) The probability density of fire detection within a specified time T in a given point of interest F with realization of particular weather conditions K;

2) The probability density of making an error in determination of coordinates E when monitoring the source of fire in the point of interest F within the time T.

Unit {4}, under the approaches described above in sections 3 and 4, generates a series of estimation criteria for the system, such as:

1) Full damage caused by the system including not only damage in connection with the loss of forest but also the cost of deployment and service of the system itself;

2) Probabilistic, accuracy, and time characteristic of the system including average probability of fire detection within the time T, average time to detect a fire with probability P, average probability of fire detection within the time T with an error not more than E.

Below a method is described for optimal arrangement of forest video monitoring system for early detection of fires.

It is an obvious fact that forest video monitoring systems with different configurations provide different detection characteristics and, consequently, different value of full damage for a territory under consideration. That is why, when preparing for deployment, it is not prior estimation of the system characteristics on-site that is important but rather a selection of optimal configuration satisfying all limitations imposed on the system and having optimal estimates of the selected criteria.

To describe a method for selection of optimal system configuration, let's list the variable parameters and variants of limitations and criteria.

### Variable Parameters

As the variable parameters data specified in Table 4 are used, i.e.
Places of location of cameras (can be selected from a predetermined list or randomly);
Types of equipment;
Configuration of monitoring routes;
Settings of automatic detection system;
Other system configuration parameters (such as communication channels' width, volume of data archives, settings of cameras, etc.).

### Imposed Limitations

Generally, any of parameters or intermediate values or derivatives thereof (different average values by time and territory, maximum and minimum values, etc.) can be used for limitation of configuration of the forest monitoring system under consideration. Most often used variants are:
Provision of detection probabilities not less than the specified ones in the entire territory or its part (e.g., with regards to the most important forest areas);
Provision of average detection times not less than the specified ones in the entire territory or its part;
Generation of system with nonrecurring or operating costs not exceeding the specified ones;
Generation of a system with engagement of a number of towers not less than one.

### Estimation Criteria

Generally, any of parameters or intermediate values or derivatives thereof can be used as criteria, which are called efficiency factors in this application. Most often used variants are:
1. Full damage caused by the system;
2. Area of territory with fire detection probability and accuracy not less than the specified threshold;
3. Area of territory with an average detection time not less than the specified threshold;
4. Nonrecurring costs;
5. Operating costs;
6. Normalized convolutions of factors under items 1-5, or multi-criterial estimates with criteria preferences.

Speaking about the method of optimal configuration selection, the following shall be noted first.

The problem of optimization of an unknown type function NP is complex (see [2], [4]). Estimation of properties of functions representing the video monitoring system operation criteria seems very complex. In such circumstances, a technically simpler solution is using the selected criteria as unknown type functions and application of algorithms for finding of pseudo optimal solution of the optimization problem. The method for selection of optimal configuration amounts to a direct shortened search of possible system configurations on-site and selection of a configuration optimal from the point of the selected criteria satisfying the imposed limitations.

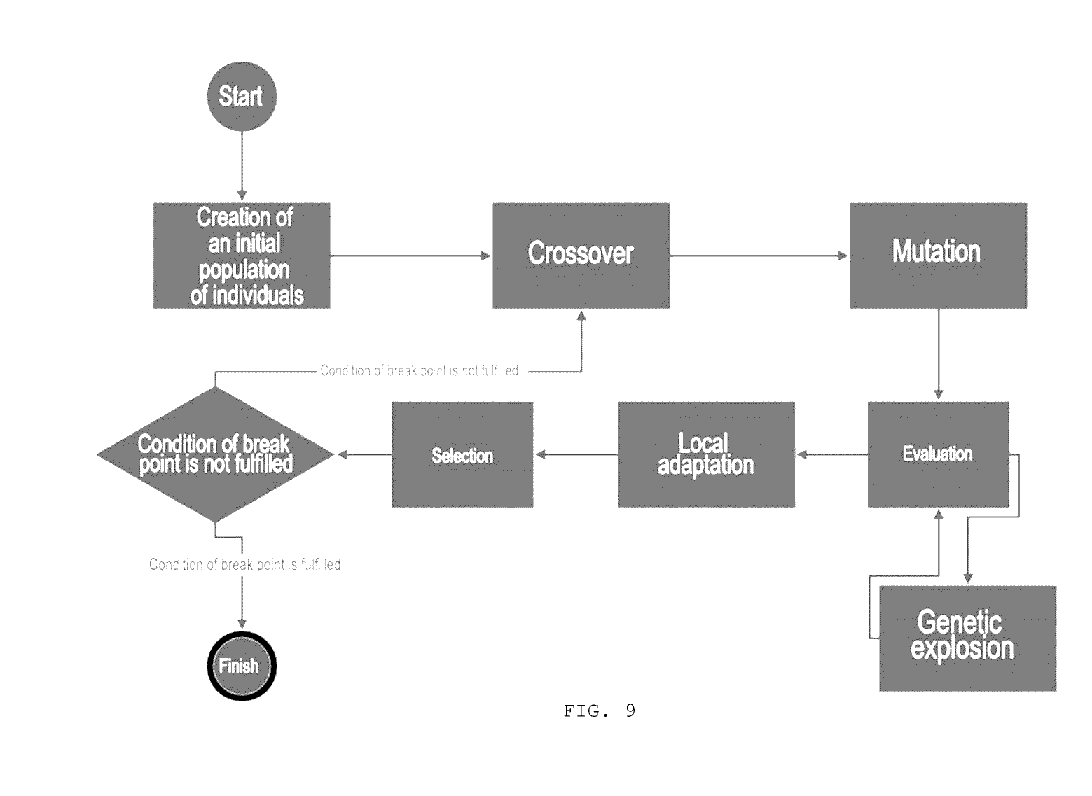

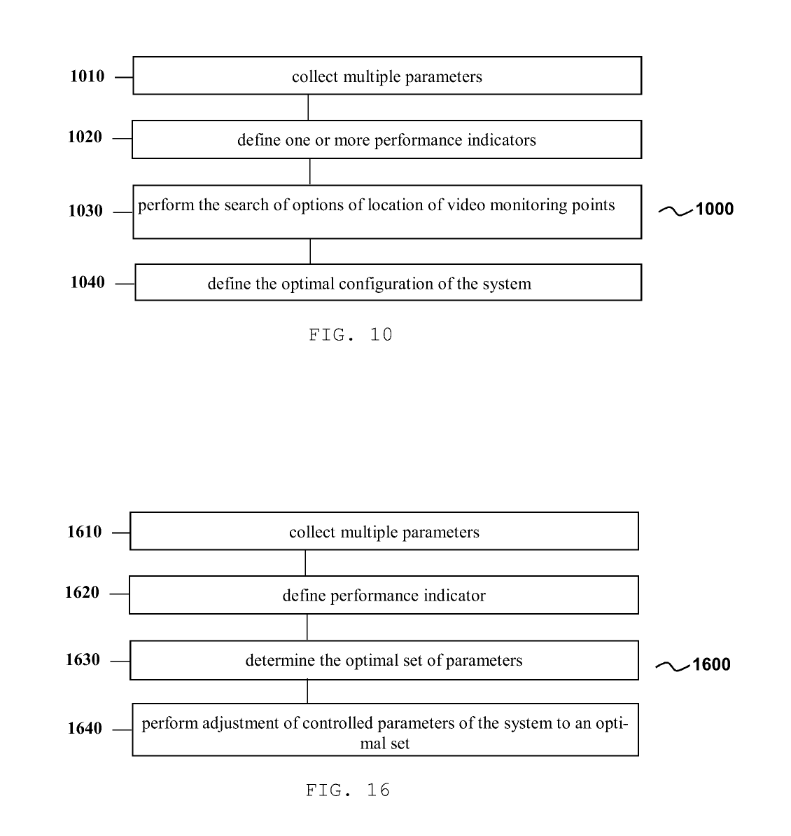

In a preferred embodiment of this invention, optimal configuration search algorithm is a hybrid evolutionary-genetic algorithm (CM. [3]) (see FIG. 9).

Obviously, the variable (or controlled) parameters (Table 4) can have a discrete (places of location and types of equipment) or continuous or conventionally continuous nature (the rest parameters). The unit of discrete parameters is a basis for provision of coding (genotype) of specimen of genetic algorithm (GA). Actually, the coding is 2kth line G with the length N, where k is the number of equipment types (the equipment is numbered from 1 to k inclusively) and N is the number of potential equipment installation places. Therefore, the meaning of i^{th} symbol of line G(i) determines which type of equipment shall be installed in i^{th} tower if G(i) is not equal to 0. G(i) equal to 0 is interpreted as the absence of equipment in the i^{th} tower. The value G(i) equal to −j means installation of two units of equipment j to the i^{th} tower in order to prevent overlying of zones obstructed with the tower structure; such system provides a video monitoring point with the viewing angle 360°. Thus, any line satisfying the above limitations determines the places and types of equipment installation in the territory. The second coding element is a set of continuous territory monitoring parameters connected with each line symbol (i.e. with each camera to be installed).

Let's assume that only one type of cameras is planned to be installed. Then Table 2 specified above will have the following form:

| | Resolution, | Zoom, | Positioning | Cost, monetary | Cost of operation, | |
|---|---|---|---|---|---|---|
| Camera ID | pixels | degrees | accuracy, degrees | value | monetary value | Other parameters |
| 1 | 1920 × 1080 | 2.7-55 | 0.1 | 150000 | 5000 | Exposure range: |
| | | | | | | 1/15000-10 s |
| | | | | | | Matrix size: 1/2.8 |
| | | | | | | Tilt range: −20-90 |
| | | | | | | F1.6-3.5 |

Tower arrangement points suitable for installation of cameras are determined. Below there is an example of the above Table 1 determining the tower arrangement places:

| Tall | | | Description | Cost of | |
|---|---|---|---|---|---|
| structure | Geographical coordinates. | | of obstruction | use, | |
| identifier | Latitude, | Tower | possibility, | monetary | |
| (ID) | longitude | height, m | degrees | value | Other parameters |
| 1 | 56° N lat. 45°E | 70 | 45° | 3000 | Communication channel |
| | long. | | | | 1 Mbps |
| 2 | 57° N lat. 45° E | 70 | 45° | 3000 | Communication channel |
| | long. | | | | 1 Mbps |
| 3 | 58° N lat. 45° E | 50 | 45° | 3000 | Communication channel |
| | long. | | | | 512 Kbps |
| 4 | 56° N lat. 44° E | 50 | 45° | 3000 | Communication channel |
| | long. | | | | 512 Kbps |
| 5 | 56° N lat. 46° E | 70 | 45° | 3000 | Communication channel |
| | long. | | | | 512 Kbps |

In this case, the following lines can be an example of coding G:

(0,0,0,0,0)—the equipment is installed to none of the towers;

(1,1,1,1,1)—one unit of equipment is installed to all towers;

(1,1,−1,1,1)—two cameras are installed to the third tower so that their obstruction zones do not overlay and one unit of equipment is installed to other towers.

Besides, with each position of line G a set of system parameters is associated connected with a relevant video monitoring point. Such set can include the following parameters:
Datum point of territory monitoring routes (set of values (P, T, Z), where P and T are bearing angle and angle of depression in a spherical coordinate system with a center in the place of camera location, the equatorial plane of which is located parallel to the geometrical horizon plane, and the position of zero bearing corresponds to north direction, Z is camera zoom (or connected values such as focal distance and camera viewing angles), type of material shot (video, images), time of shooting in one position, shooting parameters (resolution, parameters of focusing, exposure, diaphragm, shooting speed (number of frames per second), and other parameters specific for the equipment installed such as white balance, magnification, infrared (IR) filter, image post-processing parameters, etc.), parameters of computer vision system (sensitivity thresholds, accumulation parameters, clustering and selection of objects);
Camera position on the tower.

The operators of GA generation of initial population, crossover, and mutation shown in FIG. 9 are well known from the classical literature on evolutionary-genetic algorithms (see, e.g., [3]). Single-point crossover and mutation operators provide good results in solution of the problems under consideration.

When using crossover, the descendants inherit not only the genotype code but also the parameters connected with each inherited genotype position. In this case, in terms of the simulated system, such inheritance means that each of the newly generated solutions inherit a part of features of one parent and a part of the other. In other words, in a descendant solution the configurations of some monitoring points shall be taken from one parent and some from the other. If a descendant inherited “good” parts of parent solutions, it has a chance to “survive” in the course of further evolution and produce solutions with even better quality. In the preferred algorithm under consideration, two types of crossover are used: single-point and uniform.

Mutation means changing one gene with selection of an allowable set of connected parameters. In terms of the simulated system, it means “reset” of configuration of a video monitoring point with a subsequent attempt to install a random type of equipment to the tower with operating modes allowable for it.

The estimator is realized under the methodology illustrated in FIG. 8; it enables to select a criterion from a number of criteria determined by the estimation methodology or a combination thereof.

A genetic explosion operator control the genetic diversity of population. In case the diversity falls below a predetermined threshold, this operator injects new genetic material to prevent early algorithm convergence to a local optimum far from the global one.

The selection is a preferable ranking scheme with exclusion from the population of specimen from the end of the list of preferences. In this case, the population is divided into groups by the number of cameras used, from each the solutions are removed, for which other solutions are found with better values of criteria and less number of cameras used. The remaining specimens are ordered by the worsening of values of criteria. Then one specimen from the end of each group is removed until the target number of specimens in the population is reached.

As a termination condition, the limitation by the number of processed generations of population shall be used preferably but not exclusively.

Thus, the genetic algorithm is a mechanism for the study of a subspace of parameter space connected with discrete variations.

A set of optimal continuous parameters is connected with each of the selected arrangement schemes. Optimization in subspace of continuous parameters with fixed configuration of discrete parameters is performed by the unit of local adaptation of specimens by means of a statistical algorithm of global optimum search. Possible variants of realization of such optimization are well known in the art (see, e.g., [10]).

In this case, as it has already been mentioned before, the criterion is used selected as the system efficiency factor, if it is the only one, or a convolution of criteria with coefficients characterizing the importance of each separate criterion.

In the course of local adaptation, one of the two application strategies of global optimum search algorithm is used: global or local. The global strategy implies that the vector of controlled parameters is a combination of vectors of parameters connected with each permutation position. Therefore, global optimum search algorithm works simultaneously with all continuous and conventionally continuous parameters of video monitoring points under the genetic algorithm specimen under consideration. When local strategy is used, as a vector of controlled parameters the vector of continuous and conventionally continuous parameters is used connected with a point of video monitoring. In this case, the global optimum search algorithm is started for each point of video monitoring successively and repeatedly until passing of all video monitoring points results in improvement of efficiency criteria. The global strategy is characterized with considerably higher computational complexity but potentially provides a better local adaptation quality.

Thus, upon completion of work of the local adaptation unit, the population is a set of different variants of equipment arrangement on-site, for each of which an optimal set of continuous and conventionally continuous parameters of the monitoring system configuration is found.

For the sake of simplicity of presentation but without a loss of generality, let's assume that a set of continuous parameters for ach monitoring point consists of one parameter—a place of camera location on tower A (a change of the location place results in a change of position of blind area, which is formed by obstruction of the camera field of view with structural elements). Then, if the global approach is used, the vector of variable parameters for the example under consideration shall have the form (A₁, A₂, A₃, A₄, A₅), where Ai is location of camera on the i^{th} tower. If the local approach is used, the statistical algorithm will be started alternatively over one-dimensional vectors (A₁), (A₂), (A₃), (A₄), (A₅), (A₁), (A₂), (A₃), (A₄), (A₅), etc. until the efficiency of a current solution is improved.

Below, with reference to FIG. 10, a method for determination of forest video monitoring system optimal configuration 1000, an example of which is shown in FIG. 1. The forest video monitoring system considered here can be planned for deployment.

At the stage 1010, a number of parameters are collected related to the characteristics of video monitoring points and characteristics of video monitoring points' arrangement territory. A detailed example of such parameters and their obtaining methods is given above in Tables 1-6. As it has been mentioned above, among the specified parameters there are parameters, which are controlled (or variable). The examples of controlled parameters are also given above.

At the stage 1020, one or more forest video monitoring system efficiency factors are set (i.e. criteria) under the approaches specified above in sections 1-4.

At the stage 1030, a search of variants of video monitoring points' arrangement is performed among the number of possible positions in the territory. This search complies with the approach to the optimization problem described above. For this, particular arrangement of the system video monitoring points on-site is determined iteratively and for the determined video monitoring points' arrangement an optimal set of parameters is determined, which optimizes the required efficiency factor from the efficiency factors of forest video monitoring system set at the stage 1020. When performing the above iterations, the required efficiency factor is computed with variation of the relevant controlled parameters by iterations. As it has been mentioned above, the required efficiency factor can represent a convolution of different efficiency factors with coefficients characterizing the importance of each particular efficiency factor.

In the preferred embodiment, the search of variants of location of video monitoring points at the stage 1030 is terminated upon compliance with a predetermined termination condition. Such termination condition can be one, for instance, of the following:
Sustainable absence of improvement of the required efficiency factor in the course of the search iterations;
Reaching the search time limits;
Reaching the predetermined number of iterations.

When performing the search for the successive iterations, it is preferable to exclude from the consideration the video monitoring points, a change of position and/or characteristics of which has no considerable impact on the optimization performed, which enables a dynamic decrease of search variants.

At the stage 1040, an optimal configuration of forest video monitoring system is determined. For this purpose, the obtained locations of video monitoring points, for which optimal sets of parameters have been determined at the stage 1030, are compared between one another and a location variant is selected, to which the best value of efficiency factor corresponds.

In the preferred embodiment, a limitation or a number of limitations can be imposed on the required efficiency factor, the example of which is given above in section 4. It is done, particularly, to exclude from the comparison under the stage 1040 the variants of video monitoring points' location, for which the efficiency factor does not satisfy the limitations imposed on it.

The above method 1000 can be realized by means of a relevant configuration/programming of computer for this or other similar machine. Computer can be configured for performance of the above functions under the invention by means of installation of special software making the computer perform the relevant functions. It can be independently developed software, including using commercially or publicly available programming environments, libraries, API, and packages, custom-made software, or a combination thereof. In this case, the low-level aspects of such computer including hardware and basic software/firmware are well known.

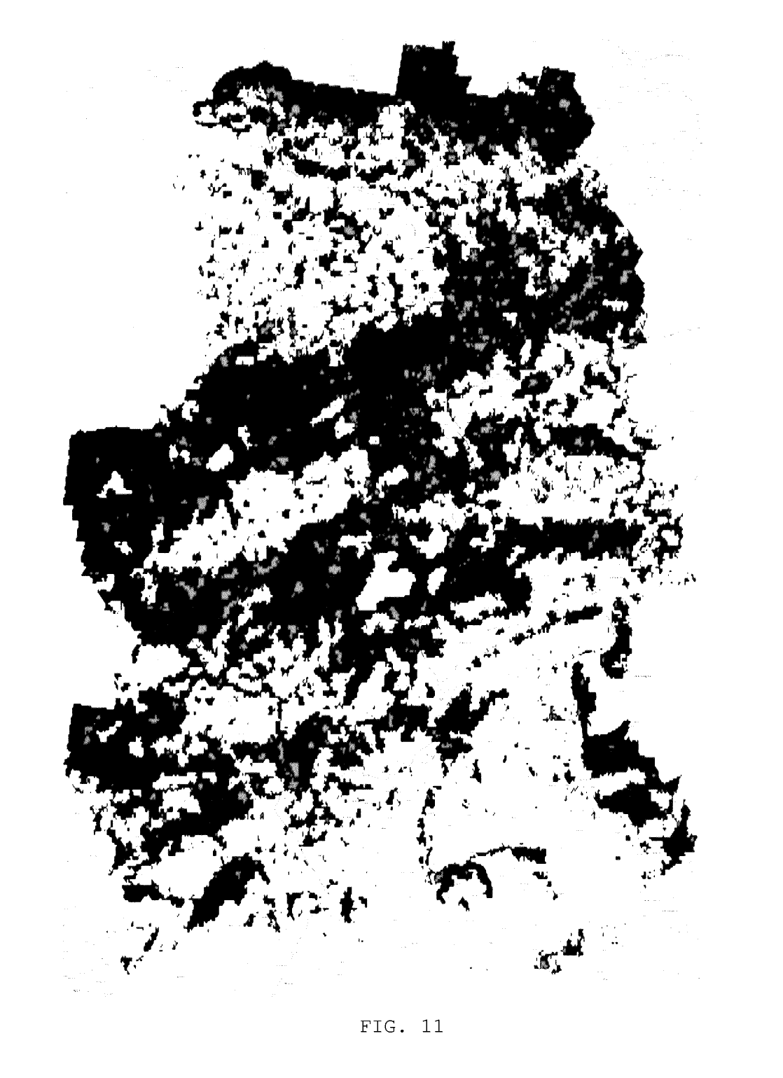

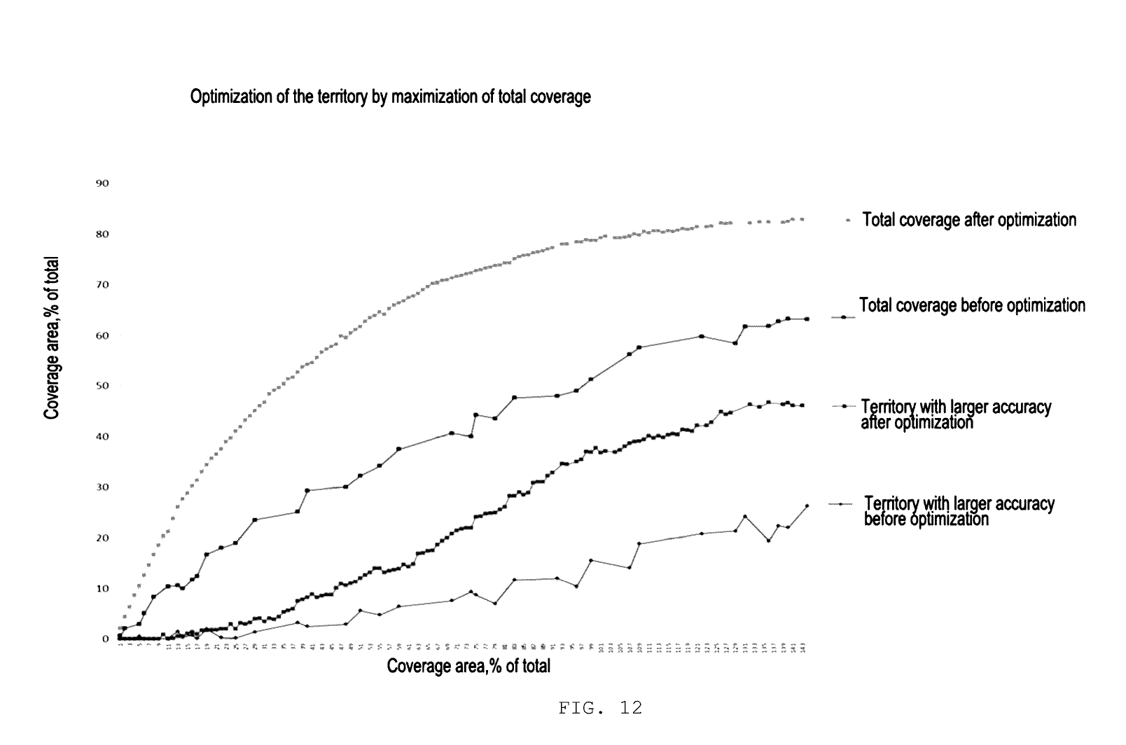

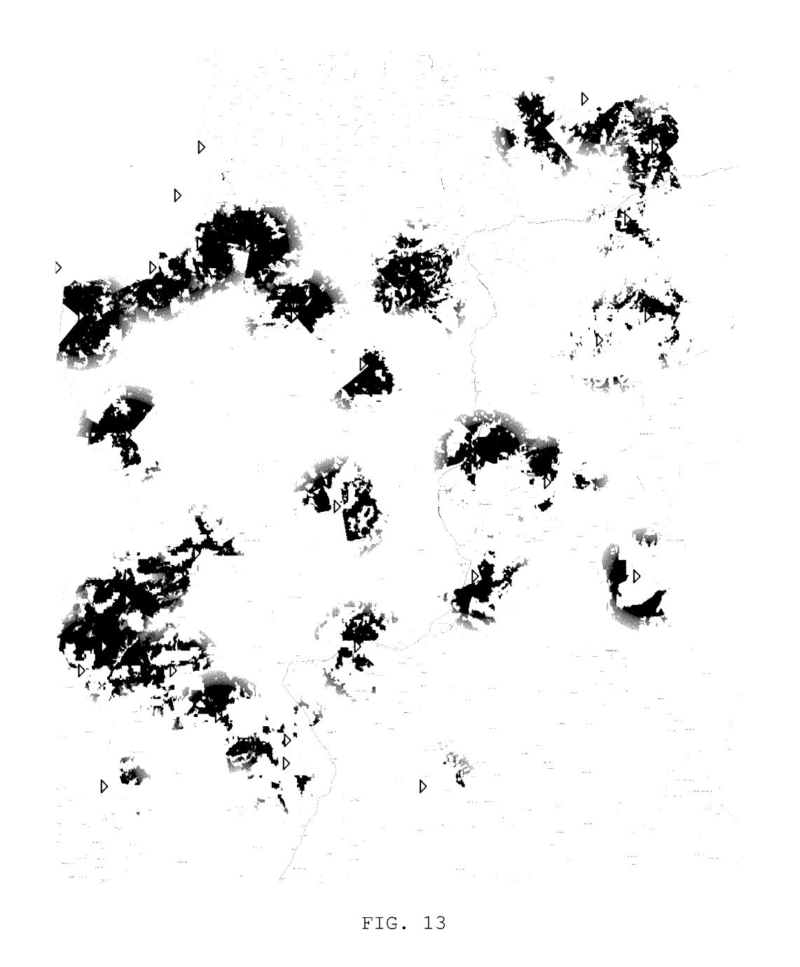

An example of application of the above optimization methods can be graphs representing the dependence of provision of the territory of interest (FIG. 11) with a detection probability not less than the specified one (the criterion is specified as “General coverage”) and a detection accuracy not less than the specified one (the criterion is specified as “Territory with more accuracy”) on the number of cameras installed (FIG. 12).

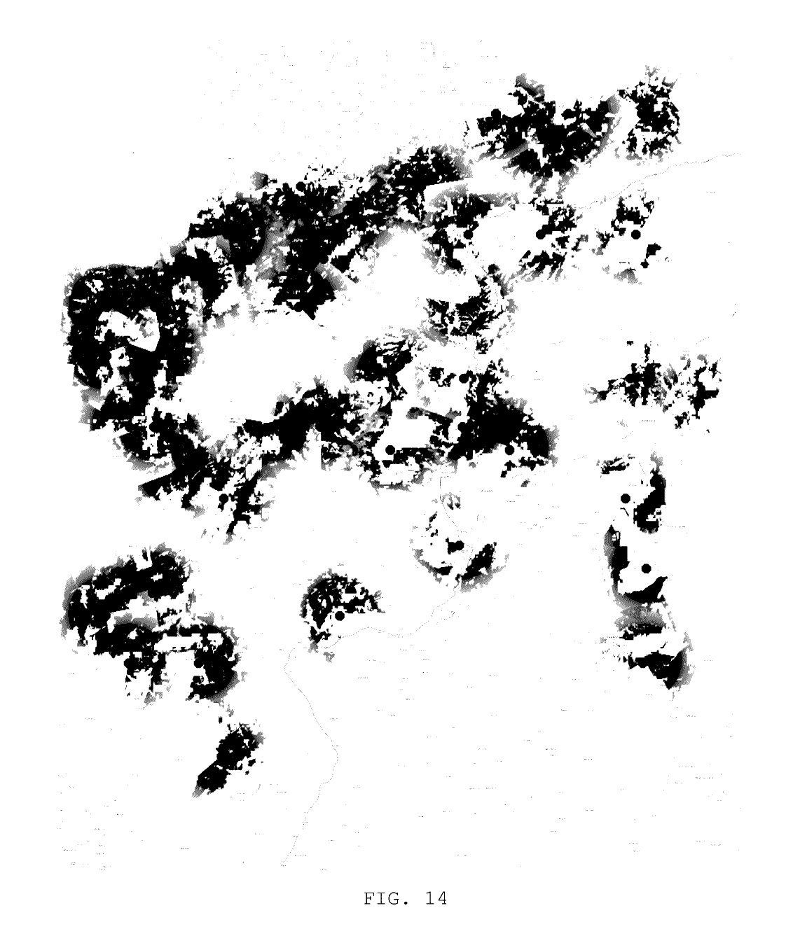

Graphs of a type “ . . . before the optimization” represent a value of the above criteria with a suboptimal selection of location of video monitoring points (e.g., on the basis of visual arrangement). Graphs of a type “ . . . after the optimization” represent the values of the same criteria for configurations with a set number of video monitoring points but selected on the basis of an offered optimization method. The values of the criteria are determined for the entire range of values of the number of video monitoring points to be installed. Thus, for instance, with suboptimal arrangement of 42 video monitoring points the area with a detection probability not less than the specified threshold is about 27% of the total area of interest. With optimal arrangement of the same 42 video monitoring points, more than 50% of the area will be covered. These facts are illustrated in FIG. 12 and FIG. 14. The illustrations enable to estimate the difference in areas visually.

In what follows a method of optimum adjustment of a forest video monitoring system to current environment conditions is described.

As Table 4 demonstrates, configuration of the system in the field comprises two major units:

Unit of information on camera placement (CP unit): places of installation, type of equipment, structure enclosure direction;

Unit of settings of territory scanning modes (TSM): routes used, scanning periods, computed vision system settings, etc.

When building the optimum system configuration, the optimization unit varies parameters comprised in both units, in this manner simultaneously selecting placement of video cameras and their future operation modes. At that, as benchmark data, historical data on changing conditions at the territory are used (without loss of generality let us speak of weather data). According to the assumption that weather conditions for the territory would be similar to historical ones, system characteristics after its deployment will correspond to those calculated for historical data.

It is obvious that weather conditions in the process of operation of the forest video monitoring system will differ from average values assumed during design. As a result, real characteristics of the system will in fact differ from design characteristics (i.e. those calculated based on historical data), as a rule for the worse. On the other hand, the fact that the system is deployed in the field means that values of the CP unit of Table 4 have been recorded but data of TSM unit can be changed by adjusting system operation modes. The general approach of selection of the optimum system configuration can be applied to system adjustment in the process of its operation (up to and including real-time adjustment) while taking into account the following facts:

1) the scope of variable parameters is narrowed down to the set determined by the TSM unit of Table 4;
2) instead of historical weather data, current weather data are used, which can be interpreted as using historical minimum depth data;
3) there is no point in calculating damage estimates because they have the meaning of “damage during a certain period”, but the procedure of adjusting the system during operation itself implies real-time assessments corresponding to current operating conditions.

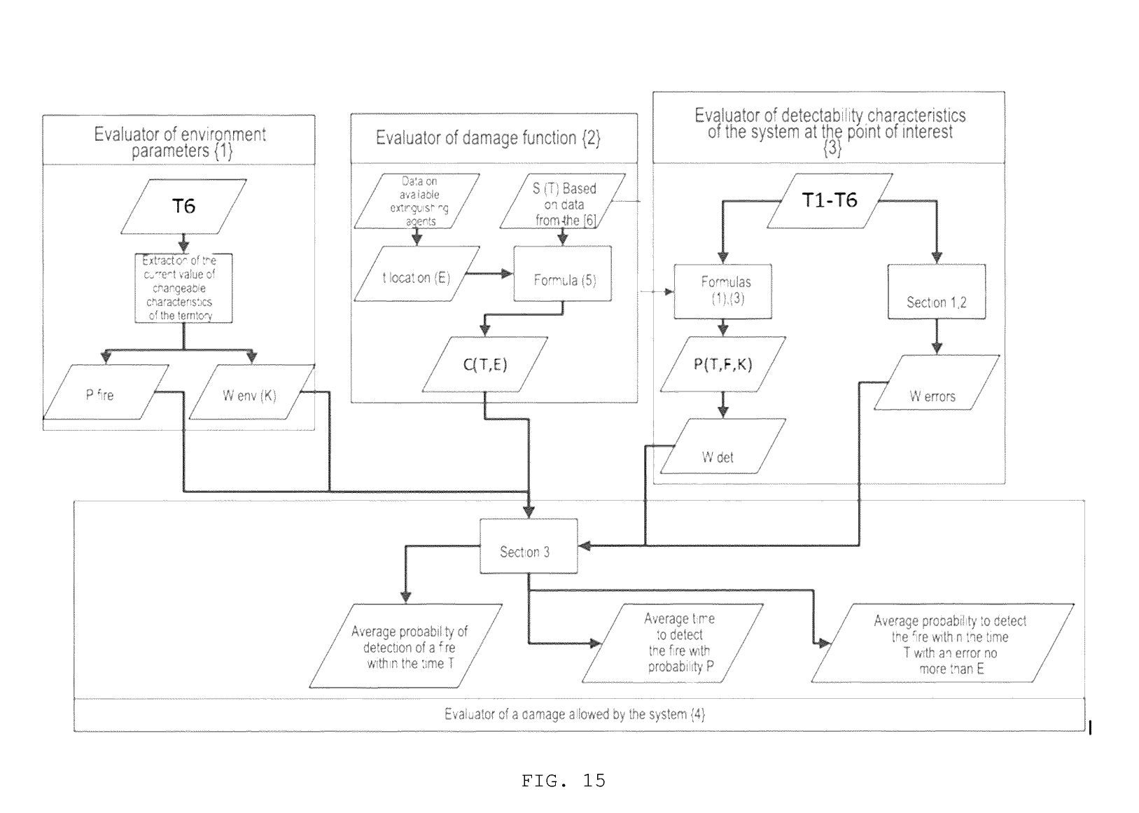

With regard to the above factors, the procedure of assessment of system performance criteria according to FIG. 8 during adjustment can be altered using the method shown in FIG. 15.

At that, the optimization procedure is naturally modified by reducing the selection of variable parameters and arranging a continuous adjustment. In fact, the optimization procedure comprises implementation of a local adaptation unit of an evolutionary genetic algorithm described above, working in case of fixed placement of the video monitoring system's points on site.

It is presumed that the length of the optimization process is less than the interval of material change of environmental conditions. On the other hand, assessment of system characteristics for current setting parameters can be received very quickly. Taking into account that the statistical search algorithm being used is of iterative nature and improves the available solution from one iteration to the next one, the search process for an optimum configuration can be planned not based on the quality of solution but on the time of search for it, along with aborting the search process when reaching a pre-set time limit. If operation modes found during the time limit ensure better knowledge of the criteria than the current ones, they are applied immediately. Such process ensures a conditionally optimal (and if sufficient computational power is available, a guaranteed epsilon-optimal (see [2])) system adjustment depending on current environment conditions.

Below, with a reference to FIG. 16, method 1600 of optimal adjustment of a forest video monitoring system 100 is described according to the preferred embodiment of this invention. In fact, this method comprises adaptation of the above method 1000 to the already deployed and functioning forest video monitoring system.

At stage 1610, similarly to stage 1010, a plurality of parameters are accumulated, related to characteristics of video monitoring points and characteristics of the territory of placement of video monitoring points. Again, some of the parameters are controllable;

At stage 1620, similarly to stage 1020, the performance criterion of the forest video monitoring system is set.

At stage 1630, similarly to stage 1030, such optimal set of parameters is determined iteratively, which optimizes the performance criterion set at stage 1620. When performing iterations, the performance criterion is calculated by varying controllable parameters based on iterations. As it has already been stated above, determining an optimal set of parameters can be completed upon expiration of the pre-set time.

Finally, at stage 1640 adjustment of controllable parameters of the forest video monitoring system is performed until achievement of the optimal set of parameters. The adjustment can be performed in fact continuously and can be performed only on condition that the resulting optimal set of parameters ensures significant improvement of functioning of the forest video monitoring system as regards the performance criterion being considered, for example, by the value equal to or exceeding the pre-set threshold.

The method described in 1600 can be implemented by a computer, in fact similar to the one described above for method 1000, using a special-purpose adjustment unit as a part of the forest video monitoring system 100. According to the preferred implementation option, the adjustment unit can be implemented as software installed on server 140 or on one or more terminal computers 120 of operator workstations. At the same time, the adjustment module can be also implemented as a separate computer hardware component of system 100, connected to network 130 for interaction with its other components and configured using the known procedure for completion of corresponding steps of method 1600. At that, the immediate implementation of the optimal system adjustment according to this invention by corresponding remote modification of equipment parameters is attributed to the widely known aspects of operation of such video monitoring systems that have been briefly mentioned before.

Parameters given in Tables 1-6 can be stored in a separate or distributed network data storage and as a part of system 100, externally in relation to it, or as a combination of these two options. In case of implementation of the adjustment module on server 140, said parameters can be stored, at least partially, on a memory device of server 140. In case of adjustment module implementation on operator terminal 120, parameters can be stored, at least partially, on the memory device on terminal 120. In case of realization of the adjustment module as a separate computer device in system 100, said parameters can be stored, at least partially, on the memory device of this computer device. Moreover, some of the parameters can be extracted from external data sources in online mode. The aspect being considered in this paragraph must be obvious to a person skilled in the art, and it is therefore not being discussed additionally.

The invention has been disclosed above with a reference to specific options of its implementation. As a part of substance of the above disclosure, for people skilled in the art other versions of invention implementation can also be obvious, different from the ones listed in this description. Correspondingly, the invention should be considered limited as to its scope only by the following claims and their equivalents.

### LIST OF CITED SOURCES

[1] Chernyak, V. S. Multiposition Radiolocation. Moscow: Radio and Communications, 1993.
[2] Garey, Michael R., Johnson, David S. Computers and Intractability: A Guide to the Theory of NP-Completeness. Moscow: Mir, 1982.
[3] Batishchev, D. I. Genetic Algorithms of Extreme Problem Solution. Teaching manual, ed. by Lvovich, Ya. E. Voronezh, 1995. 64 pages.
[4] Papadimitriou, Christos, Steiglitz, Kenneth. Combinatorial Optimization: Algorithms and Complexity. Moscow: Mir, 1985.
[5] Kate Gregory, Ade Miller. Accelerated Massive Parallelism with Microsoft® Visual C++. Microsoft Press, 2012.
[6] Decree of the Government of the Russian Federation No. 838 dated 29 Dec. 2006. On approval of the method of distribution of subventions from the Federal Fund of Compensations between constituents of the Russian Federation for exercising certain authorities of the Russian Federation in the sphere of forestry, exercising which has been entrusted to state authorities of constituents of the Russian Federation.
[7] Guidelines of the Ministry of Natural Resources of the Russian Federation. Manual on extinguishing natural fires, project of UNDP/ICI. Expanding the network of protected areas for preservation of the Altai-Sayan ecological region. Krasnoyarsk, 2011.
[8] Order No. 287 of the Federal Forestry Agency of Russia dated 5 Jul. 2011. On approving classification of the natural fire hazard in forests depending on weather conditions.
[9] Order No. 53 of the Federal Forestry Agency of Russia dated 3 Apr. 1998.
[10] Strongin, R. G. Numeric Method in Multiextremal Problems. Optimization and Examination of Operations. Main editorial office for physics and mathematics reference materials of Nauka Publishing House. Moscow, 1978. 240 pages.

We claim:

1. A method for determining the optimal configuration of a forest video monitoring system, comprising a plurality of video monitoring points, each of said points comprising a video camera in a tall structure, said method comprising the steps of:
accumulating a plurality of parameters, attributed to characteristics of video monitoring points and characteristics of the territory of placement of video monitoring points, said territory characteristics comprising landscape characteristics, weather data and forest fire data, wherein at least some of the parameters attributed to characteristics of video monitoring points are controllable;
setting one or more performance criteria of the forest video monitoring system, wherein each of the criteria is an integral quantity described by a probabilistic model generalizing at least a portion of the above plurality of parameters;
searching through options of placement of video monitoring points using the plurality of possible positions at the territory, by which means:
placement of video monitoring points is determined, and
for the determined placement of video monitoring points, the optimal set of parameters optimizing at least one performance criterion out of said one or more performance criteria of the forest video monitoring system, wherein said performance criterion is calculated by varying corresponding controllable parameters; and
an optimal configuration of the forest video monitoring system is determined by:
comparing resulting options of placement of video monitoring points, for which optimal parameter sets are determined, and
selecting a placement option with the best value of said performance criterion.

2. The method according to claim 1, additionally comprising a step, wherein one or more restrictions are set applied to said at least one performance criterion, wherein options of placement of video monitoring points, for which this performance criterion does not satisfy the applied restrictions, are not accounted for in said comparison.

3. The method according to claim 1, wherein said one or several performance criteria comprise a plurality of performance criteria of the forest video monitoring system, wherein said at least one performance criterion comprises a convolution of performance criteria of said plurality with coefficients characterizing importance of each individual performance criterion.

4. The method according to claim 1, additionally comprising a step, wherein in the course of said searching through, one or more video monitoring points are excluded from consideration if changing their positions and/or characteristics does not have material influence of the optimal configuration of the forest video monitoring system being determined.

5. The method according to claim 1, wherein parameters attributed to characteristics of video monitoring points comprise possible resolutions, range of permissible camera movement and movement speed, capabilities of communication channels, singing points, video camera capabilities for encoding the video stream.

6. The method according to claim 5, wherein the variable parameters are: configurations of datum points of territory monitoring routes (P,T,Z), wherein P and T are bearing angle and angle of depression in a spherical coordinate system with a center in the place of camera location, the equatorial plane of which is located parallel to the geometrical horizon plane, and the position of zero bearing corresponds to north direction, Z is camera zoom (or connected values such as focal distance and camera viewing angles), type of material shot (video, images); time of shooting in one position, shooting parameters (resolution, parameters of focusing, exposure, diaphragm, shooting speed (number of frames per second), and other parameters specific for the equipment installed such as white balance, magnification, infrared (IR) filter, image post-processing parameters, etc.); parameters of computer vision system (sensitivity thresholds, accumulation parameters, clustering and selection of objects).

7. The method according to claim 1, wherein said one or more performance criteria comprise one or more of the following: total or average damage permitted by the system at the territory being examined, average probability of discovering a fire within the pre-set time at the territory or in specific points of the territory, average time required for fire discovery with pre-set probability at the territory or in specific points of the territory, average change of discovering a fire within the pre-set time with an error not exceeding the one pre-set for the territory or specific points of the territory.

8. The method according to claim 2, wherein said one or several restrictions comprise one or more of the following: restriction on the cost of commissioning the system; restriction for the total cost of ownership during the set period; restriction for the number of commissioned monitoring points; lower limit of the possibility of discovering a fire at the territory or in specific points; upper limit of the time of discovering fire at the territory or in specific points; upper limit of the error of determining coordinates at the territory or in specific points; restriction of the number of required system operators; prohibition of using more than one video camera in a tall structure.

9. The method according to claim 1, wherein said searching through options of placement of video monitoring points is aborted after fulfillment of a pre-set fulfillment condition, wherein the pre-set fulfillment condition is one of the following: stable lack of improvement of said performance criterion when performing iterations of said searching through process, exhausting the time quota offered for searching through, achieving the pre-set number of iterations.

10. The method according to claim 1, wherein when calculating said at least one performance criterion, the estimated probability of occurrence of a fire at the territory during a period of time and probability density of realization of specific environmental conditions is calculated, dependence of damage caused by the fire on the time of failure to extinguish the fire and the error in determining its coordinates is calculated.

11. A method of optimal adjustment of a forest video monitoring system, comprising a plurality of distributed video monitoring points, each of said points comprising a video camera in a tall structure, said method comprising the steps of:
accumulating a plurality of parameters attributed to characteristics of video monitoring points and characteristics of the territory of placement of video monitoring points, said territory characteristics comprising landscape characteristics, weather data and forest fire data, wherein at least some of the parameters attributed to characteristics of video monitoring points are controllable;
setting at least one performance criterion of the forest video monitoring system, wherein each of the criteria is an integral quantity described by a probabilistic model generalizing at least a portion of the above plurality of parameters;
determining an optimal set of parameters that optimizes said at least one performance criterion of the forest video monitoring system, wherein said performance criterion is calculated while varying controllable parameters;
adjusting controllable parameters of the forest video monitoring system to the optimal set of parameters.

12. The method according to claim 11, wherein weather data comprise data on current weather conditions.

13. The method according to claim 11, wherein said adjustment is performed on condition that the obtained optimal set of parameters ensures improvement of operation of the forest video monitoring system as regards said at least performance criterion by a value equal to or exceeding a pre-set threshold.

14. A forest video monitoring system, comprising:
a plurality of remotely controlled video monitoring points, each of which comprises a video camera in a tall structure;
one or more operator computer terminals; and
a computer-aided adjustment module,
wherein the adjustment module is configured to be able to calculate at least one performance criterion of the forest video monitoring system, said performance criterion being is an integral quantity described by a probabilistic model generalizing at a plurality of parameters attributed to characteristics of video monitoring points and characteristics of the territory of placement of video monitoring points, wherein territory characteristics comprise landscape characteristics, weather data and forest fire data, wherein at least some of the parameters attributed to characteristics of video monitoring points are controllable;
wherein said adjustment module is configured to:
determine the optimum set of parameters optimizing said at least one performance criterion of the forest video monitoring system, wherein said performance criterion is iteratively calculated by varying controllable parameters, and
perform adjustment of controllable parameters of the forest video monitoring system to the optimum set of parameters.

15. The forest video monitoring system according to claim 14 that additionally comprises a server, wherein the adjustment module comprises software executed on the server.

16. The forest video monitoring system according to claim 14, wherein the adjustment module comprises software executed on at least one operator computer terminal.

17. The forest video monitoring system according to claim 14, wherein the adjustment unit comprises a computing device configured with the capability of exchanging data with video monitoring points and operator computer terminals.

18. The forest video monitoring system according to claim 14, wherein the adjustment module is configured to perform said adjustment continuously.

19. The forest video monitoring system according to claim 14, wherein the adjustment module is configured to perform said adjustment on condition that the received optimal set of parameters improves operation of the forest video monitoring system as regards said at least one performance criterion by a value equal or exceeding a pre-set threshold.

20. The forest video monitoring system according to claim 14, wherein the adjustment module is configured to abort said determination of the optimal set of parameters upon expiration of a certain time.
